(19) United States
(12) Patent Application Publication
(10) Pub. No.: US 2017/0219243 A1
(43) Pub. Date: Aug. 3, 2017

(54) HVAC REGISTER GRILLE WITH SENSOR-ACTIVATED LIGHT

(71) Applicant: T.A. INDUSTRIES, INC., Santa Fe Springs, CA (US)

(72) Inventor: Yongki YI, Chino Hills, CA (US)

(73) Assignee: T.A. Industries, Inc.

(21) Appl. No.: 15/423,036

(22) Filed: Feb. 2, 2017

Related U.S. Application Data
(60) Provisional application No. 62/290,332, filed on Feb. 2, 2016.

(51) Int. Cl. F24F 13/08; F21V 7/00; F21V 23/04; F21S 9/02; F24F 13/15; F21V 33/00

(52) U.S. Cl. CPC F24F 13/082; F24F 13/15; F21V 33/0092; F21V 23/0471; F21V 23/0464; F21S 9/02; F21V 7/0066; F24F 2221/02; F24F 2011/005

(57) ABSTRACT

An HVAC register or return grille with an integrated nightlight, a battery-operated nightlight module and an area on the grille suitable for mounting the nightlight module. The nightlight module is operatively coupled to the grille and fitted with motion sensing technology to activate the light when a user nears the device. The integration of nightlight technology into HVAC grilles allows for a discrete nightlight location and enhances the utility of conventional HVAC register and return grilles.

### CROSS-REFERENCE TO RELATED APPLICATION

This application claims benefit of co-pending U.S. provisional patent application 62/290,332, filed Feb. 2, 2016, entitled “HVAC REGISTER GRILLE WITH SENSOR-ACTIVATED LIGHT”, and commonly assigned to the assignee of the present application, the disclosure of which is incorporated by reference in its entirety herein.

### FIELD

The present disclosure relates, in exemplary embodiments, to residential HVAC registers and returns.

### BACKGROUND

Conventional HVAC registers and returns are single function, either directing or blocking airflow to a particular room or allowing air to return to the source of conditioning. The grille of the register and return is typically utilitarian in design, however many designer versions exist in the marketplace.

Battery operated nightlights have become increasingly more common with the advancement of LED lighting and motion sensing technology. These nightlights can be placed anywhere and, due to their low power draw, can function for one year or greater without need to service them by replacing the battery. Many versions of portable nightlights require adhesives or other hardware to secure them to walls or furniture.

It would be desirable to provide a discrete location for a nightlight while improving the utility of a conventional HVAC grille.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In exemplary embodiments, an HVAC register or return grille with an integrated battery operated nightlight wherein the nightlight module is operatively coupled to the grille. A reflector surface on the nightlight module directs light onto surrounding walls and surfaces when activated. The nightlight can be activated by a variety of means including, but not limited to, motion sensing, a timer or a manual switch. The nightlight module is comprised of a top reflector surface and a battery access area not visible by the user during normal use wherein a battery can either be replaced or recharged. The light source in the nightlight module is preferably directional so the user does not see the light source itself, but rather the reflection of the light source on surrounding surfaces.

Other features will become apparent upon reading the following detailed description of certain exemplary embodiments, when taken in conjunction with the appended claims

### BRIEF DESCRIPTION OF THE DRAWINGS

The drawings disclose exemplary embodiments in which like reference characters designate the same or similar parts throughout the figures of which:

FIG. 1 is a perspective view of a nightlight HVAC grille assembly according to one exemplary embodiment;

FIG. 2 is a perspective exploded view of the nightlight HVAC grille assembly of FIG. 1;

FIG. 3 is a perspective view of a nightlight module assembly according to one exemplary embodiment;

FIG. 4 is a perspective partial exploded view of the nightlight module assembly of FIG. 3;

FIG. 5 is a bottom perspective view of the nightlight HVAC grille and nightlight module assembly showing adjustable louvers in an open position; and,

FIG. 6 is a bottom perspective view of the nightlight HVAC grille and nightlight module assembly showing adjustable louvers in a closed position.

### DETAILED DESCRIPTION

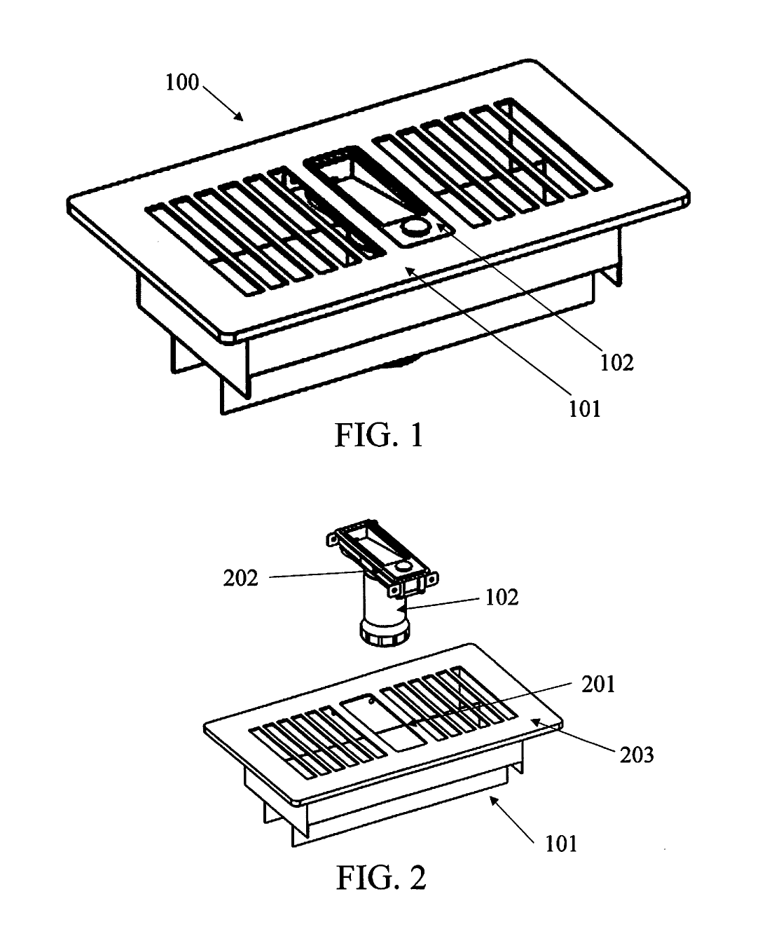

FIGS. 1 and 2 are perspective views of one exemplary embodiment of a nightlight HVAC grille assembly 100. A nightlight module 102 is attached to a HVAC grille plate 101 with fasteners, not shown, from below. The HVAC grille 101 has an opening 201 extending through the top surface 203. In exemplary embodiments, the opening 201 can be generally in the center of the grille plate 101. Alternatively, the opening 201 can be located off-center or toward one side edge of the grille plate 101.

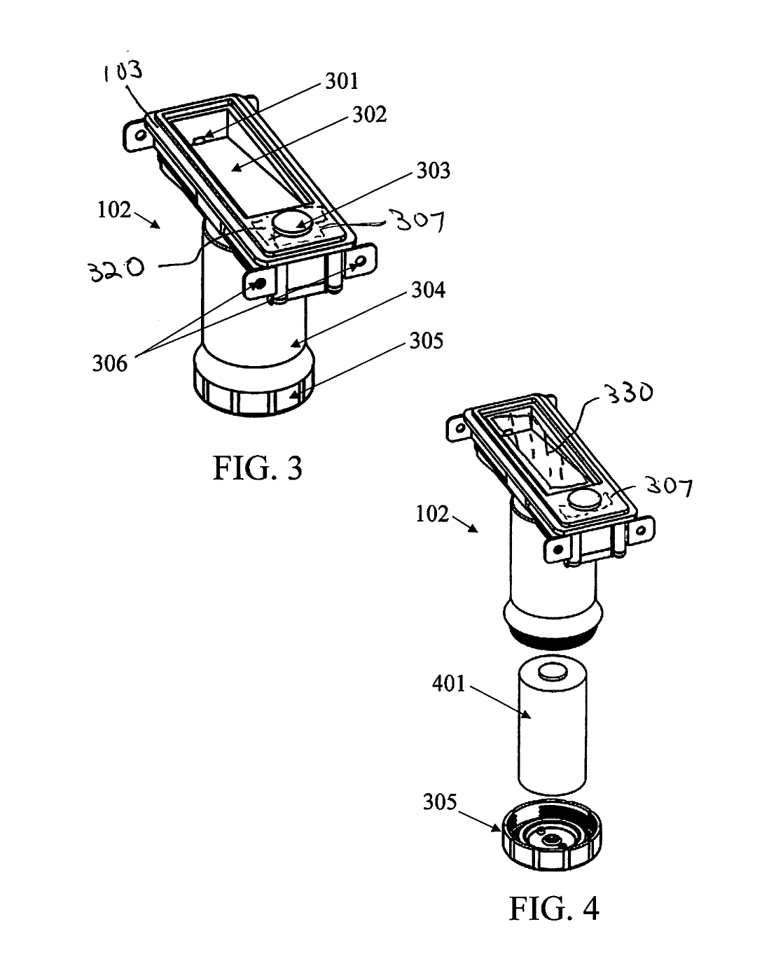

FIGS. 3-4 show one exemplar embodiment of a nightlight assembly 102 having a housing 103, which includes a LED light source 301, such as a conventional LED bulb, and a reflector surface 302, which directs light emitted from the LED light source 301 toward surrounding objects and surfaces in the ambient environment of the grille assembly 100. The light source 301 may comprise a plurality of LED bulbs, which may all be the same color, or may be different colors. It is to be understood that other light-emitting devices can be used, such as, but not limited to, incandescent, halogen, luminescent, and the like. In one exemplary embodiment, a lens 303 such as, but not limited to, a Fresnel-type lens, may be included and positioned beneath a motion sensor and/or light sensor 307 (shown in phantom) disposed in the housing 103. The sensor 307 may be a single sensor designed to detect motion, light or both. Alternatively, two sensors can be utilized, whereby one sensor is designed to detect motion and the other is designed to detect light. In other exemplary embodiments, more than two sensors can be utilized. The lens 303 directs ambient light and movement information to the sensor or sensors 307 and functionality of the nightlight is controlled by an integrated circuit 320, which is incorporated in the housing 103. In exemplary embodiments, the nightlight module assembly 102 also includes a battery housing 304, a battery cover 305, as shown in FIGS. 3-4. In exemplary embodiments, the battery housing 304 includes mounting points 306 which allow for attachment to the HVAC grille assembly. A battery 401 provides one exemplary embodiment of operational power to the nightlight module assembly 102 and a battery cover 305 that secures the battery and provides electrical contact. IN exemplary embodiments the nightlight assembly

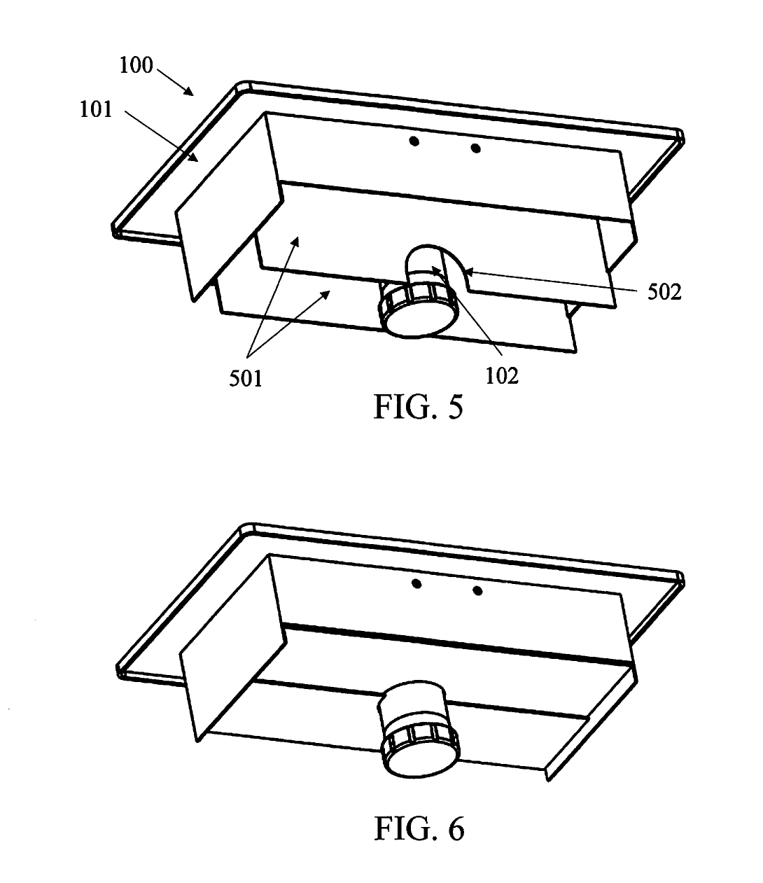

FIG. 5 is a bottom perspective view of an exemplary embodiment of a nightlight HVAC grille assembly 100 in which the HVAC grille 101 has adjustable louvers 501, shown in their open position, which when closed (as shown in FIG. 6) block air flow to the area the nightlight HVAC grille assembly 100 is installed. The louvers 501 have a relief cut 502, which allows for the louvers 501 to close around the nightlight module assembly 102 without interference.

In exemplary embodiments, the nightlight module assembly 102 further includes a transparent or translucent cover 330 that can be removably associated with at least a portion of the housing 103, such as, but not limited to, by fitting within a slot or groove (not shown) in the housing 103 and retained by a clip, friction fit, snap fit, slot, fastener or other retaining means known to those skilled in the art. The cover 330 can be used to prevent dust and dirt from entering the area around the light source 301 or reflector surface 302.

In exemplary embodiments, the light source of the nightlight module assembly is an LED, however any appropriate known lighting technology or yet to be invented lighting technology can be employed. Certain exemplary embodiments described herein incorporate an HVAC register plate, however this present assembly may alternatively include a HVAC return (which typically would not include adjustable louvers).

In one exemplary embodiment, the exemplary embodiments described above can be modified so that the sensor 307 can be at least one sensor, such as, but not limited to a heat, smoke, carbon monoxide (or other gas), glass breakage (e.g., high frequency sound sensor), or other sensor. Upon detecting a threshold level of material, the sensor can send a signal to the circuit 320 (or the circuit can detect a sensor signal or change in condition), which can cause the light source to flash to provide a visual indicator of an alert condition. Optionally, such an embodiment may also include a tone or other audible signal generator that can provide an audible sound in the event that there is an alert condition (e.g., fire, smoke, gas, or the like).

In exemplary embodiments, the assembly 100 may have a power source comprising an electrical connection to an AC or other power source, such as, but not limited to, ordinary home or office electrical system. Such a power source may also optionally include a battery, as described hereinabove, as a backup power source in the event of a power outage.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims. “Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

What is claimed is:

1. A nightlight HVAC grille, comprising:
a) An HVAC register with an opening on the top surface;
b) a nightlight module assembly which operatively couples to the HVAC register and installs to the opening on the top surface of the HVAC register; and,
c) a power source capable of powering the device.

2. The nightlight HVAC grille device of claim 1, wherein the light source is an LED.

3. The nightlight HVAC grille device of claim 1, wherein the nightlight module contains an angled surface capable of reflecting the emitted light onto surrounding surfaces and objects.

4. The nightlight HVAC grille device of claim 1, wherein the nightlight module contains a light sensor and a motion sensor to detect movement in the dark thereby activating the light source.

5. The nightlight HVAC grille of claim 1, wherein the power source is a battery.

6. A nightlight HVAC grille, comprising:
a) An HVAC return with an opening on the top surface; and
b) a nightlight module assembly which operatively couples to the HVAC return and installs to the opening on the top surface of the HVAC return;
c) a power source capable of powering the device.

7. The nightlight HVAC grille of claim 6, wherein the light source is at least one light source selected from the group consisting of LED, incandescent, and halogen bulbs.

8. The nightlight HVAC grille of claim 6, wherein the nightlight module contains an angled surface capable of reflecting the emitted light onto surrounding surfaces and objects.

9. The nightlight HVAC grille of claim 6, wherein the nightlight module contains a light sensor and a motion sensor to detect movement in the dark thereby activating the light source.

10. The nightlight HVAC of claim 6, wherein the power source is a battery.
